(19) United States
(12) Patent Application Publication
(10) Pub. No.: US 2026/0147263 A1
(43) Pub. Date: May 28, 2026

(54) WAVELENGTH CONVERSION DEVICE, LIGHT SOURCE DEVICE, AND PROJECTOR

(71) Applicant: SEIKO EPSON CORPORATION, Tokyo (JP)

(72) Inventor: Akira EGAWA, SHIOJIRI-SHI (JP)

(21) Appl. No.: 19/395,545

(22) Filed: Nov. 20, 2025

(30) Foreign Application Priority Data
Nov. 22, 2024 (JP) 2024-203740

(51) Int. Cl. G03B 21/20

(52) U.S. Cl. CPC G03B 21/204; G03B 21/2066

(57) ABSTRACT

A wavelength conversion device includes a base member having a first surface, a wavelength conversion layer disposed at an incident side of first light in a first wavelength band with respect to the base member and configured to convert the first light incident thereon into second light in a second wavelength band different from the first wavelength band, a reflective film disposed between the wavelength conversion layer and the first surface and configured to reflect light incident thereon from the wavelength conversion layer, and a bonding portion disposed between the reflective film and the first surface and configured to bond the reflective film and the base member to each other, wherein the bonding portion contains silver and a movement suppressing substance configured to suppress movement of silver.

The present application is based on, and claims priority from JP Application Serial Number 2024-203740, filed November 22, 2024, the disclosure of which is hereby incorporated by reference herein in its entirety.

### BACKGROUND

### Technical Field

The present disclosure relates to a wavelength conversion device, a light source device, and a projector.

### Related Art

In the past, a fluorescent light source device including a laser diode and a fluorescent light emitting member has been known as a light source device that can be used for a projector (see, e.g., JP-A-2014-194895).

The fluorescence light source device described in JP-A-2014-194895 converts light in a blue region emitted from a laser diode into fluorescence in a green region by a fluorescence emitting member formed of a phosphor. The fluorescence emitting member is formed by bonding a phosphor plate onto a surface of a substrate via a bonding metal layer. Specifically, the gold film that forms an obverse surface of the substrate and a metal film that is made of a nickel-platinum-gold film or a nickel-gold film and is formed at a reverse surface side of the phosphor plate are bonded to each other with the bonding metal layer. Examples of the bonding metal layer include what contains silver, such as a silver sintered material and a silver paste.

JP-A-2014-194895 is an example of the related art.

In recent years, in order to increase the bonding strength between the substrate and a light-reflecting layer provided to the phosphor plate, a technique of arranging an auxiliary bonding layer containing the same metal as the bonding metal layer may be adopted in some cases.

However, when a temperature difference in the phosphor plate increases due to incidence of excitation light, stress is generated. There is a possibility that due to such stress, the phosphor plate and the light-reflecting film may be partially separated from each other in the bonding metal layer. In this case, there is a possibility that an efficiency of heat transfer from the phosphor plate to the substrate decreases, and a light use efficiency of the fluorescence emitting member decreases.

Therefore, there has been a demand for a configuration capable of suppressing an occurrence of the separation between the phosphor plate and the substrate.

### SUMMARY

A wavelength conversion device according to a first aspect of the present disclosure includes a base member having a first surface, a wavelength conversion layer disposed at an incident side of first light in a first wavelength band with respect to the base member and configured to convert the first light incident thereon into second light in a second wavelength band different from the first wavelength band, a reflective film disposed between the wavelength conversion layer and the first surface and configured to reflect light incident thereon from the wavelength conversion layer, and a bonding portion disposed between the reflective film and the first surface and configured to bond the reflective film and the base member to each other, wherein the bonding portion contains silver and a movement suppressing substance configured to suppress movement of silver.

A light source device according to a second aspect of the present disclosure includes a light source configured to emit the first light, and the wavelength conversion device according to the first aspect described above on which the first light emitted from the light source is incident.

A projector according to a third aspect of the present disclosure includes the light source device according to the second aspect described above, a light modulation device configured to modulate the light emitted from the light source device, and a projection optical device configured to project the light modulated by the light modulation device.

### BRIEF DESCRIPTION OF THE DRAWINGS

FIG. 1 is a schematic diagram showing a configuration of a projector in a first embodiment.

FIG. 2 is a schematic diagram showing a configuration of a light source device in the first embodiment.

FIG. 3 is a cross-sectional view showing a wavelength conversion device according to the first embodiment.

FIG. 4 is a cross-sectional view showing a wavelength conversion device according to a second embodiment.

FIG. 5 is a cross-sectional view showing a wavelength conversion device according to a third embodiment.

FIG. 6 is a cross-sectional view showing a wavelength conversion device according to a fourth embodiment.

### DESCRIPTION OF EMBODIMENTS

### First Embodiment

A first embodiment of the present disclosure will hereinafter be described based on the drawings.

### Schematic Configuration of Projector

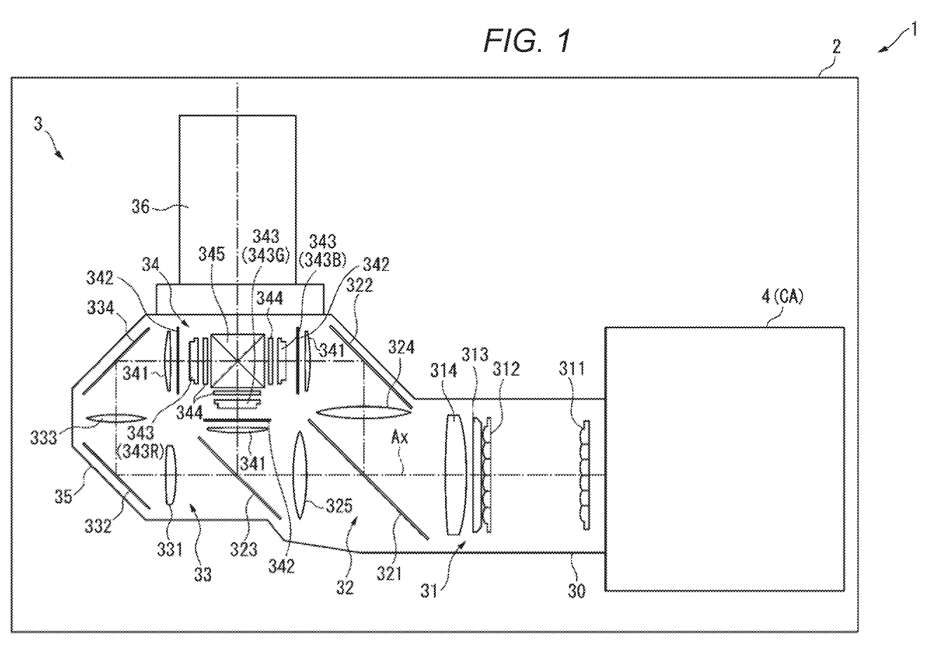

FIG. 1 is a schematic diagram showing a configuration of a projector 1 according to the present embodiment.

The projector 1 according to the present embodiment projects image light according to image information. As shown in FIG. 1, the projector 1 includes an exterior housing 2 and an image projection device 3 housed in the exterior housing 2. Besides the above, although not shown, the projector 1 includes a control device that controls an operation of the projector 1, a power supply device that supplies electronic components of the projector 1 with electric power, and a cooling device that cools a cooling target in the projector 1.

### Configuration of Image Projection Device

The image projection device 3 forms image light according to image information input thereto to project the image light thus formed. The image projection device 3 includes a light source device 4, an image light generation device 30 and a projection optical device 36.

The light source device 4 emits illumination light to a homogenization optical system 31 of the image light generation device 30. A configuration of the light source device 4 will be described later in detail.

The image light generation device 30 generates the image light from the illumination light emitted from the light source device 4. The image light generation device 30 includes the homogenization optical system 31, a color separation optical system 32, a relay optical system 33, a light modulation device 34, and an optical component housing 35.

The homogenization optical system 31 homogenizes the illumination light emitted from the light source device 4. The illumination light thus homogenized travels via the color separation optical system 32 and the relay optical system 33 to illuminate modulation areas of light modulation elements 343 described later. The homogenization optical system 31 includes two lens arrays 311, 312, a polarization conversion element 313, and a superimposing lens 314.

The color separation optical system 32 separates the illumination light incident from the homogenization optical system 31 into colored light of red, green, and blue. The color separation optical system 32 includes two dichroic mirrors 321, 323, a reflecting mirror 322, which reflects the blue light separated by the dichroic mirror 321, a lens 324 disposed between the dichroic mirror 321 and the reflecting mirror 322, and a lens 325 disposed between the dichroic mirrors 321, 323.

The relay optical system 33 is provided to a light path of the red light, which is longer than light paths of other colors light to suppress a loss of the red light. The relay optical system 33 includes an incident-side lens 331, a relay lens 333, and reflecting mirrors 332, 334. It is assumed in the present embodiment that the red light is guided to the relay optical system 33. However, this is not a limitation, and it is possible to adopt a configuration in which, for example, the blue light has a longer light path than those of the other colored light and is guided to the relay optical system 33.

The light modulation device 34 modulates the colored light of red, green, and blue incident thereon, and combines the colored light thus modulated to form the image light. The light modulation device 34 includes three field lenses 341, three incident-side polarization plates 342, three light modulation elements 343, and three exit-side polarization plates 344, which are all provided in accordance with the colored light incident thereon, and one color combining optical system 345.

The light modulation elements 343 modulate the light from the light source device 4 to form the image light. Specifically, the light modulation elements 343 modulate the colored light incident from the incident-side polarization plates 342 in accordance with image signals to emit the colored light thus modulated, respectively. The three light modulation elements 343 include a light modulation element 343R, which modulates the red light, a light modulation element 343G, which modulates the green light, and a light modulation element 343B, which modulates the blue light. Examples of the light modulation elements 343 include a transmissive liquid crystal panel.

The color combining optical system 345 combines the three colors of colored light respectively modulated by the light modulation elements 343R, 343G, and 343B with each other. The image light obtained by the combination of the color combining optical system 345 enters the projection optical device 36. The color combining optical system 345 is configured with a cross dichroic prism having a substantially cuboidal shape in the present embodiment, but may instead be configured with a plurality of dichroic mirrors.

The optical component housing 35 houses the homogenization optical system 31, the color separation optical system 32, and the relay optical system 33 described above. Note that a designed optical axis Ax is set in the image projection device 3, and the optical component housing 35 holds the homogenization optical system 31, the color separation optical system 32, the relay optical system 33, and the light modulation device 34 at predetermined positions on the optical axis Ax. The light source device 4, the light modulation device 34, and the projection optical device 36 are disposed at predetermined positions on the optical axis Ax.

The projection optical device 36 projects the image light incident from the light modulation device 34 onto a projection target surface such as a screen. That is, the projection optical device 36 projects the image light formed by the light modulation device 34. The projection optical device 36 can be formed as, for example, a combination lens including a plurality of lenses and a lens barrel housing the plurality of lenses.

### Configuration of Light Source Device

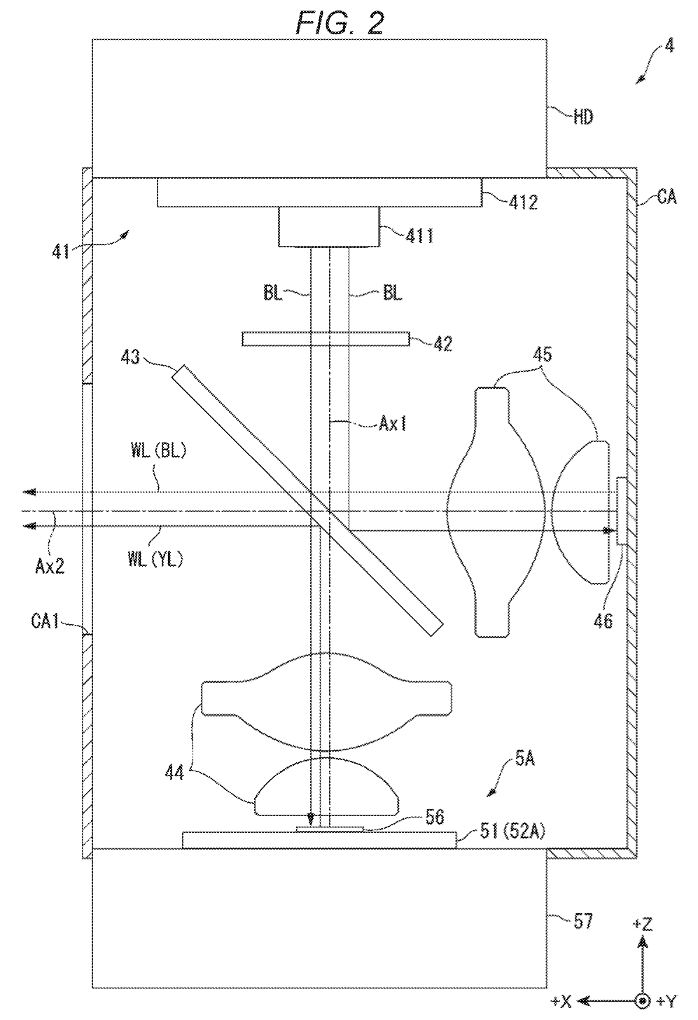

FIG. 2 is a schematic diagram showing a configuration of the light source device 4.

The light source device 4 emits illumination light WL in the +X direction toward the homogenization optical system 31. As shown in FIG. 2, the light source device 4 includes a light source 41, a diffuse transmission section 42, a light separator 43, a first light collection element 44, a wavelength conversion device 5A, a second light collection element 45, a diffusive optical member 46, and a light source housing CA.

In the following description, three directions perpendicular to each other are defined as a +X direction, a +Y direction, and a +Z direction. In the present embodiment, the +Z direction is set as a direction in which a principal ray is emitted from the wavelength conversion device 5A, and the +X direction orthogonal to the +Z direction is set as a direction in which the illumination light WL is emitted from the light source device 4.

Although not shown in the drawings, an opposite direction to the +X direction is defined as a -X direction, an opposite direction to the +Y direction is defined as a -Y direction, and an opposite direction to the +Z direction is defined as a -Z direction. The -Z direction is also a direction in which the light source 41 emits the excitation light. Further, an axis along the +X direction is defined as an X axis, and an axis along the +Z direction is defined as a Z axis.

In the light source device 4, an optical axis Ax1 along the Z axis and an optical axis Ax2 along the X axis are set, and the optical axis Ax1 and the optical axis Ax2 are perpendicular to each other. The optical components of the light source device 4 are disposed on the optical axis Ax1 or the optical axis Ax2.

Specifically, the light source 41, the diffuse transmission section 42, the light separator 43, the first light collection element 44, and the wavelength conversion device 5A are disposed on the optical axis Ax1.

The diffusive optical member 46, the second light collection element 45, and the light separator 43 are disposed on the optical axis Ax2. That is, the light separator 43 is disposed at an intersection of the optical axis Ax1 and the optical axis Ax2.

The optical axis Ax2 is linked to the optical axis Ax of the image projection device 3 at the lens array 311 of the homogenization optical system 31.

### Configuration of Light Source

The light source 41 emits light in the -Z direction. The light source 41 includes a light emitting element 411 and a substrate 412.

The light emitting element 411 emits blue light BL. The blue light BL is the excitation light that excites a phosphor in the wavelength conversion device 5A. The light emitting element 411 is, for example, a semiconductor laser that emits a laser beam having a peak wavelength of 455 nm.

The substrate 412 is fixed to an inner surface of the light source housing CA in a state of supporting the light emitting element 411. The substrate 412 receives heat from the light emitting element 411 and transfers the heat thus received to a heat dissipating member HD exposed outside the light source housing CA.

### Configuration of Diffuse Transmission Section

The diffuse transmission section 42 diffuses the blue light BL incident from the light source 41 to emit light with an illuminance distribution homogenized. The blue light BL emitted from the diffuse transmission section 42 is incident on the light separator 43. Examples of a configuration of the diffuse transmission section 42 include a configuration including a hologram, a configuration in which a plurality of small lenses is arranged on a plane perpendicular to an optical axis, and a configuration in which a surface transmitting the light is a coarse surface.

Note that in place of the diffuse transmission section 42, a homogenizer optical element including a pair of multi-lens arrays may be adopted in the light source device 4. When the diffuse transmission section 42 is adopted, a distance from the light source 41 to the light separator 43 can be shortened compared to when the homogenizer optical element is adopted.

### Configuration of Light Separator

The light separator 43 has a function of a half mirror that transmits part of the blue light BL incident from the light source 41 via the diffuse transmission section 42 and reflects the rest of the blue light BL. That is, out of the blue light BL incident from the diffuse transmission section 42, the light separator 43 transmits first partial light as the part of the blue light BL in the -Z direction to be incident on the first light collection element 44, and reflects second partial light as the rest of the blue light BL in the -X direction to be incident on the second light collection element 45.

The light separator 43 further has a function of a dichroic mirror that reflects fluorescence YL incident from the wavelength conversion device 5A in the +Z direction and transmits the blue light BL incident from the diffusive optical member 46 in the +X direction.

### Configuration of First Light Collection Element

The first light collection element 44 converges the first partial light having transmitted through the light separator 43 on the wavelength conversion device 5A. Further, the first light collection element 44 collimates the fluorescence YL incident from the wavelength conversion device 5A to be incident on the light separator 43 along the +Z direction.

### Schematic Configuration of Wavelength Conversion Device

The wavelength conversion device 5A is a reflective wavelength conversion device that converts first light in a first wavelength band incident thereon into second light in a second wavelength band different from the first wavelength band, and diffuses to emit the second light in a direction opposite to the incident direction of the first light. The second light is, for example, unpolarized fluorescence YL having a peak wavelength in a range of 500 to 700 nm, and the fluorescence YL includes the green light and the red light. A configuration of the wavelength conversion device 5A will be described later in detail.

The fluorescence YL emitted from the wavelength conversion device 5A passes through the first light collection element 44 along the optical axis Ax1 and is then incident on the light separator 43. The fluorescence YL incident on the light separator 43 is reflected by the light separator 43 toward the +X direction, and is emitted outside the light source device 4 along the optical axis Ax2.

### Configuration of Second Light Collection Element

The second light collection element 45 converges the second partial light incident from the light separator 43 on the diffusive optical member 46. The second light collection element 45 collimates the blue light incident from the diffusive optical member 46 to be incident on the light separator 43 along the +Z direction.

### Configuration of Second Light Collection Element

The diffusive optical member 46 reflects and diffuses the blue light BL incident from the second light collection element 45 at a diffusion angle substantially equal to the diffusion angle of the fluorescence YL emitted from the wavelength conversion device 5A or a diffusion angle slightly smaller than the diffusion angle of the fluorescence YL. That is, the diffusive optical member 46 reflects and diffuses the incident light without converting the wavelength of the incident light.

The blue light BL reflected by the diffusive optical member 46 toward the +X direction passes through the second light collection element 45, then passes through the light separator 43 in the +X direction, and is emitted outside the light source device 4 along with the fluorescence YL.

As described above, the illumination light WL emitted outside the light source device 4 is white light in which the blue light BL and the fluorescence YL containing the green light and the red light are mixed with each other.

The illumination light WL is emitted from the light source device 4 in the +X direction via a passage port CA1 provided to the light source housing CA.

### Configuration of Light Source Housing

The light source housing CA is a housing of the light source device 4, and is one of internal housings housed inside the exterior housing 2. The light source housing CA houses the light source 41, the diffuse transmission section 42, the light separator 43, the first light collection element 44, the wavelength conversion device 5A, the second light collection element 45, and the diffusive optical member 46. In the present embodiment, the light source housing CA is a sealed housing hard for dust to enter. However, this is not a limitation, and the light source housing CA is only required to house the optical components described above.

The light source housing CA has the passage port CA1. The passage port CA1 is an opening for the illumination light WL to pass through the light source housing CA.

### Detailed Configuration of Wavelength Conversion Device

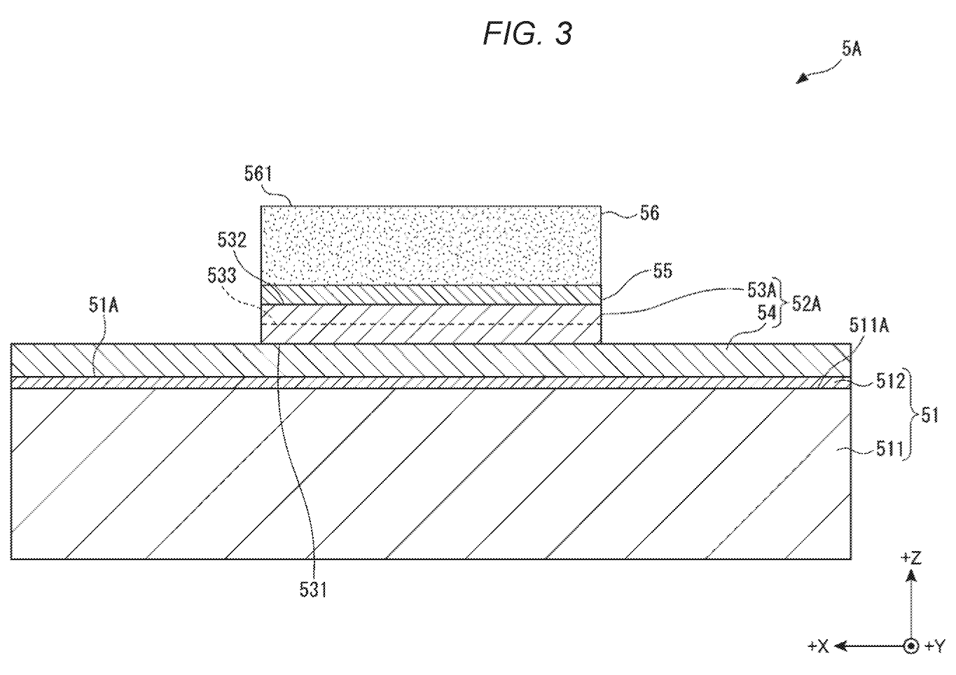

FIG. 3 is a diagram showing a cross-section of the wavelength conversion device 5A along an X-Z plane. That is, FIG. 3 is a diagram showing the cross-section of the wavelength conversion device 5A along the plane defined by the -Z direction, which is the incident direction of the blue light BL on the wavelength conversion device 5A, and the +X direction perpendicular to the -Z direction.

As described above, the wavelength conversion device 5A emits, in the +Z direction, the fluorescence YL obtained by converting the blue light BL incident along the -Z direction. As shown in FIG. 3, the wavelength conversion device 5A includes a heat dissipation member 57 shown in FIG. 2 in addition to a base member 51, a bonding portion 52A, a reflective film 55, and a wavelength conversion layer 56. In the wavelength conversion device 5A, the wavelength conversion layer 56, the reflective film 55, the bonding portion 52A, the base member 51, and the heat dissipation member 57 are disposed in this order toward the -Z direction, which is a direction of incidence of the blue light BL. In other words, in the wavelength conversion device 5A, the heat dissipation member 57, the base member 51, the bonding portion 52A, the reflective film 55, and the wavelength conversion layer 56 are disposed in this order toward the +Z direction, which is an exit direction of the fluorescence YL from the wavelength conversion device 5A.

### Configuration of Base Member

The base member 51 supports the reflective film 55 and the wavelength conversion layer 56 bonded to the base member 51 with the bonding portion 52A. The base member 51 includes a substrate 511 and a metal film 512.

The substrate 511 supports the wavelength conversion layer 56, and in addition, releases, to the heat dissipation member 57, heat transferred from the wavelength conversion layer 56. The substrate 511 is a plate-shaped body made of either copper or a copper alloy. The content of copper or a copper alloy in the substrate 511 is sufficiently equal to or higher than a predetermined rate, and is preferably equal to or higher than, for example, 90 %. Further, the substrate 511 may contain impurities.

The metal film 512 is disposed at substantially the entire area of a first surface 511A facing the +Z direction in the substrate 511, and forms a first face 51A of the base member 51. That is, the metal film 512 forms the first face 51A facing the +Z direction in the base member 51. The metal film 512 contains any one of noble metals of silver (Ag), gold (Au), platinum (Pt), and palladium (Pd). Specifically, the metal film 512 contains particles of the noble metal.

The metal film 512 has a function of increasing the bonding strength between the base member 51 and the bonding portion 52A, and the first face 51A formed of the metal film 512 is bonded to a bonding member 54 described later of the bonding portion 52A.

### Configuration of Wavelength Conversion Layer

Before describing the bonding portion 52A, the wavelength conversion layer 56 and the reflective film 55 will be described.

The wavelength conversion layer 56 is disposed at an end portion in the +Z direction on which the blue light BL is incident in the wavelength conversion device 5A. The wavelength conversion layer 56 is a phosphor layer containing a phosphor excited by the blue light BL entering a plane of incidence 561 facing the +Z direction. Examples of the phosphor include a YAG:Ce phosphor containing cerium as an activator. The blue light BL directly enters the wavelength conversion layer 56 from the first light collection element 44, and the wavelength conversion layer 56 emits the fluorescence YL due to the incidence of the blue light BL.

### Configuration of Reflective Film

The reflective film 55 is disposed at the base member 51 side with respect to the wavelength conversion layer 56. That is, the reflective film 55 is located at the -Z direction side that is an opposite side to the incident side of the blue light BL with respect to the wavelength conversion layer 56. Further, the reflective film 55 is disposed at an opposite side to the base member 51 with respect to the bonding portion 52A so as to be in contact with the bonding portion 52A.

The reflective film 55 reflects, to the wavelength conversion layer 56, the light incident from the wavelength conversion layer 56. That is, the reflective film 55 is coupled to a surface at an opposite side to the incident side of the blue light BL in the wavelength conversion layer 56. The reflective film 55 has a multilayer structure including a total reflection layer.

### Configuration of Bonding Portion

The bonding portion 52A is disposed between the first face 51A of the base member 51 and the reflective film 55, bonds the base member 51 and the reflective film 55 to each other, and by extension, bonds the base member 51, the reflective film 55, and the wavelength conversion layer 56 to each other. The bonding portion 52A includes a bonding film 53A and the bonding member 54.

### Configuration of Bonding Member

The bonding member 54 is disposed at the base member 51 side that is an opposite side to the reflective film 55 with respect to the bonding film 53A, and is in contact with the first face 51A of the base member 51. That is, the bonding member 54 is disposed at the -Z direction side with respect to the bonding film 53A and is in contact with the first face 51A.

The bonding member 54 contains metal nanoparticles, specifically, nanoparticles of the noble metal. In the present embodiment, the bonding member 54 is made of a sintered material containing silver nanoparticles.

### Configuration of Bonding Film

The bonding film 53A is disposed at the reflective film 55 side with respect to the bonding member 54 and is in contact with the reflective film 55. The bonding film 53A bonds the base member 51 and the reflective film 55 to each other by being fixed to the bonding member 54. In the present embodiment, the bonding film 53A contains silver. Specifically, the bonding film 53A is a bonding film containing silver particles.

By firing the bonding film 53A and the bonding member 54 described above at, for example, 200 °C, the silver particles in the bonding film 53A and the silver nanoparticles in the bonding member 54 are diffusion-bonded by thermocompression bonding. Thus, the base member 51 and the reflective film 55 are bonded to each other.

In addition to silver (Ag), the bonding film 53A contains a movement suppressing substance that suppresses movement of silver. In the present embodiment, the bonding film 53A contains copper (Cu) as the movement suppressing substance. Specifically, the bonding film 53A includes therein a movement suppressing layer 533 which is disposed between a first end surface 531 at the base member 51 side in the bonding film 53A and a second end surface 532 at the wavelength conversion layer 56 side in the bonding film 53A, and which is formed as a layer of copper particles.

As described above, the wavelength conversion layer 56 generates heat when converting the blue light BL, which is the excitation light, into the fluorescence YL.

Since the blue light BL is incident on the surface facing the +Z direction in the wavelength conversion layer 56, stress is generated inside the wavelength conversion layer 56 due to a difference between the temperature of a portion on which the blue light BL is directly incident and the temperature of a portion on which the blue light BL is not directly incident. Due to such stress, the silver particles contained in the bonding film 53A move. For example, the silver particles contained in the bonding film 53A move toward the bonding member 54, or the silver particles diffusion-bonded to the silver nanoparticles move. In such a case, there is a possibility that separation occurs between the reflective film 55 and the bonding film 53A, separation occurs in the bonding film 53A, or separation occurs between the bonding film 53A and the bonding member 54. When at least one of these separations occurs, not only the bonding strength between the base member 51 and the wavelength conversion layer 56 decreases, but also the heat generated in the wavelength conversion layer 56 cannot be quickly transferred to the base member 51 side, and thus, the wavelength conversion layer 56 cannot be effectively cooled. Then, when the cooling of the wavelength conversion layer 56 becomes insufficient, the efficiency of conversion by the wavelength conversion layer 56 from the blue light BL to the fluorescence YL decreases.

To cope with the above, the present discloser has found out that the occurrence of the separations described above can be suppressed by suppressing the movement of the silver particles in the bonding portion. That is, the present discloser has found out that the movement of the silver particles can be suppressed by making the bonding film 53A contain copper as the movement suppressing substance, and thus, the occurrence of the separations can be suppressed. Further, the present discloser has found out that the movement of the silver particles in the bonding film 53A can be effectively suppressed by disposing copper as a layer between the first end surface 531 at the base member 51 side in the bonding film 53A and the second end surface 532 at the wavelength conversion layer 56 side in the bonding film 53A. That is, the present discloser has found out that the movement of the silver particles in the bonding film 53A can be effectively suppressed by forming the movement suppressing layer 533 made of the copper particles in the bonding film 53A.

Therefore, in the wavelength conversion device 5A having the configuration described above, since the movement of the silver particles in the bonding portion 52A can be effectively suppressed and the heat generated in the wavelength conversion layer 56 can be efficiently transferred to the base member 51, it is possible to suppress a decrease in the efficiency of conversion from the blue light BL to the fluorescence YL by the wavelength conversion layer 56 and to suppress the occurrence of damage due to the heat of the wavelength conversion layer 56.

Note that when the dimension along the Z axis of the bonding film 53A is 100 nm or more and 400 nm or less, the dimension along the Z axis of the movement suppressing layer 533 formed of the copper particles is 1 nm or more and 3 nm or less. This is because, when the movement suppressing layer 533 is relatively thin, the diffusion suppressing effect of the silver particles becomes low, and when the movement suppressing layer 533 is relatively thick, the copper particles are diffused and deposited on the surface of the bonding film 53A to hinder the bonding between the silver particles and the silver nanoparticles. That is, when the thickness of the movement suppressing layer 533 formed of the copper particles is within the range described above, it is possible to suppress the diffusion of the silver particles and the decrease in the bonding strength at the same time.

Similarly, the ratio of copper to silver in the bonding film 53A is preferably 1/400 or more and 3/100 or less in terms of molar number. By the ratio of copper to silver being within such a range, it is possible to suppress the diffusion of silver particles and the decrease in bonding strength at the same time.

In addition, when the movement suppressing layer 533 is disposed at, for example, an intermediate position between the first end surface 531 and the second end surface 532, the diffusion of the silver particles can be more effectively suppressed. However, this is not a limitation, and it is sufficient for the movement suppressing layer 533 to be disposed, for example, between the first end surface 531 and the second end surface 532.

### Advantages of First Embodiment

The projector 1 according to the present embodiment described hereinabove provides the following advantages.

The projector 1 includes the light source device 4, the light modulation device 34 that modulates the light emitted from the light source device 4, and the projection optical device 36 that projects the light modulated by the light modulation device 34.

The light source device 4 includes the light source 41 that emits the blue light BL as the first light and the wavelength conversion device 5A on which the blue light BL emitted from the light source 41 is incident.

The wavelength conversion device 5A includes the base member 51 having the first face 51A, the bonding portion 52A, the reflective film 55, and the wavelength conversion layer 56.

The wavelength conversion layer 56 is disposed at the incident side of the blue light BL with respect to the base member 51 to convert the blue light BL incident thereon into the fluorescence YL. The blue light BL corresponds to the first light in the first wavelength band, and the fluorescence YL corresponds to the second light in the second wavelength band different from the first wavelength band.

The reflective film 55 is disposed between the wavelength conversion layer 56 and the first face 51A of the base member 51 to reflect the light incident from the wavelength conversion layer 56.

The bonding portion 52A is disposed between the reflective film 55 and the first face 51A of the base member 51 to bond the reflective film 55 and the base member 51 to each other. The bonding portion 52A contains silver and the movement suppressing substance that suppresses movement of silver.

According to such a configuration, since the bonding portion 52A contains the movement suppressing substance that suppresses the movement of silver, it is possible to suppress a decrease in bonding strength with the bonding portion 52A due to the movement of silver over time. Therefore, the occurrence of partial separation between the wavelength conversion layer 56 and the base member 51 can be suppressed. Therefore, it is possible to suppress a decrease in efficiency of the heat transfer from the wavelength conversion layer 56 to the base member 51, and it is possible to suppress a decrease in use efficiency of the blue light BL by the wavelength conversion layer 56, and by extension, to suppress a decrease in efficiency of the conversion from the blue light BL to the fluorescence YL by the wavelength conversion layer 56.

Further, accordingly, it is possible to increase the luminance of the light emitted from the light source device 4, and by extension, it is possible to increase the luminance of the image projected from the projector 1.

In the wavelength conversion device 5A, the bonding portion 52A includes the bonding film 53A containing silver and the movement suppressing substance, and the bonding member 54 that contains silver nanoparticles, is disposed at the base member 51 side with respect to the bonding film 53A, and is bonded to the bonding film 53A.

According to such a configuration, since the bonding portion 52A includes the bonding film 53A and the bonding member 54, the bonding strength between the reflective film 55 and the base member 51 with the bonding portion 52A can be increased.

Further, since the bonding film 53A contains the movement suppressing substance, silver in the bonding film 53A is prevented from moving to the bonding member 54 side to cause the reflective film 55 and the bonding film 53A to be partially separated from each other. Therefore, it is possible to suppress a decrease in efficiency of the heat transfer from the wavelength conversion layer 56 to the base member 51 via the reflective film 55, and it is possible to suppress a decrease in the use efficiency of the blue light BL by the wavelength conversion layer 56.

In the wavelength conversion device 5A, the base member 51 includes the substrate 511 having the first surface 511A and the metal film 512 that contains the noble metal and is disposed at the first surface 511A. The metal film 512 forms the first face 51A.

According to such a configuration, the bonding strength between the base member 51 and the bonding member 54 can be increased.

In the wavelength conversion device 5A, the movement suppressing substance is copper.

According to such a configuration, movement of silver in the bonding portion 52A is suppressed by copper. Thus, it is possible to effectively achieve the effect of the wavelength conversion device 5A described above.

In the wavelength conversion device 5A, the ratio of copper to silver in the bonding film 53A is 1/400 or more and 3/100 or less in terms of molar number.

Here, when the ratio of copper to silver is relatively low, the effect of suppressing the movement of silver is low, whereas when that ratio is high, copper is deposited on the surface of the bonding film 53A and the bonding strength between the bonding film 53A and the bonding member 54 is reduced.

To cope with the above, by setting the ratio of copper to silver within the range described above, it is possible to suppress each of the decrease in bonding strength due to movement of silver and the decrease in bonding strength due to precipitation of copper. Therefore, it is possible to effectively provide the advantages of the wavelength conversion device 5A described above.

In the wavelength conversion device 5A, the movement suppressing substance is disposed as a layer between the first end surface 531 of the bonding film 53A at the base member 51 side and the second end surface 532 of the bonding film 53A at the wavelength conversion layer 56 side.

According to such a configuration, copper can be efficiently introduced into the bonding film 53A, and in addition, the movement of silver can be effectively suppressed by copper as a layer. Therefore, it is possible to effectively provide the advantages of the wavelength conversion device 5A described above.

### Second Embodiment

Next, a second embodiment of the present disclosure will be described.

A projector according to the present embodiment includes substantially the same configuration as that of the projector 1 according to the first embodiment, but is different therefrom in the composition of the bonding film provided to the wavelength conversion device. Specifically, the wavelength conversion device according to the present embodiment is different from the wavelength conversion device 5A according to the first embodiment in the movement suppressing substance contained in the bonding film. Note that in the following description, the same or substantially the same portions as the portions having already been described are denoted by the same reference numerals, and the description thereof will be omitted.

### Schematic Configurations of Projector and Light Source Device

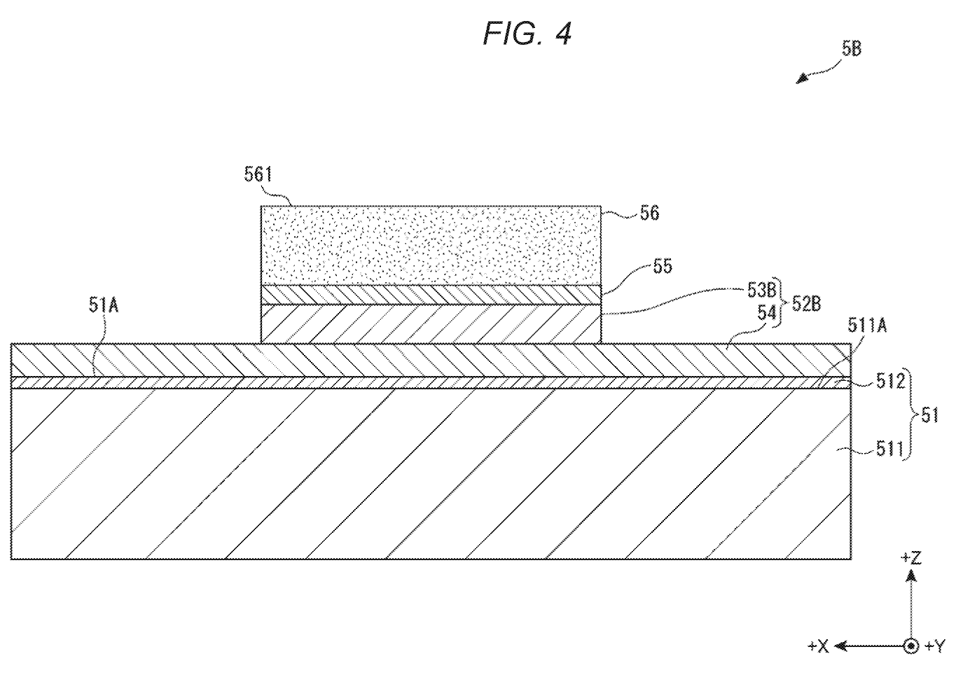

FIG. 4 is a diagram showing a cross-section along the X-Z plane of the wavelength conversion device 5B provided to the light source device of the projector according to the present embodiment.

The projector according to the present embodiment includes substantially the same configuration and functions as those of the projector 1 according to the first embodiment except that the wavelength conversion device 5B illustrated in FIG. 4 is provided instead of the wavelength conversion device 5A according to the first embodiment. That is, the light source device according to the present embodiment includes substantially the same configuration and functions as those of the light source device 4 according to the first embodiment except that the wavelength conversion device 5B is provided instead of the wavelength conversion device 5A.

### Configuration of Wavelength Conversion Device

The wavelength conversion device 5B includes substantially the same configuration and functions as those of the wavelength conversion device 5A according to the first embodiment except that a bonding portion 52B is provided instead of the bonding portion 52A according to the first embodiment. That is, the wavelength conversion device 5B includes the heat dissipation member 57 (not shown in FIG. 4) in addition to the base member 51, the bonding portion 52B, the reflective film 55, and the wavelength conversion layer 56.

The bonding portion 52B has substantially the same configuration and functions as the bonding portion 52A according to the first embodiment except that the bonding film 53B is provided instead of the bonding film 53A according to the first embodiment. That is, the bonding portion 52B includes the bonding film 53B and the bonding member 54, and bonds the base member 51, the reflective film 55, and the wavelength conversion layer 56 to each other.

### Configuration of Bonding Film

The bonding film 53B contains silver (Ag) and also contains a silver alloy as the movement suppressing substance. Examples of the silver alloy include an APC alloy (Ag-Pd-Cu alloy) and an APC-TR alloy (manufactured by FURUYA METAL Co., Ltd.).

Here, the present discloser has found out that the movement of the silver particles due to the stress described above is suppressed by the bonding film containing the silver alloy exemplified above as the movement suppressing substance similarly to the copper particles in the bonding film 53A according to the first embodiment. Therefore, the wavelength conversion device 5B including the bonding film 53B containing silver and the silver alloy instead of the bonding film 53A can also achieve the same advantages as those of the wavelength conversion device 5A according to the first embodiment.

### Advantages of Second Embodiment

The projector according to the present embodiment described hereinabove provides the following advantages in addition to substantially the same advantages provided by the projector 1 according to the first embodiment.

In the wavelength conversion device 5B, the movement suppressing substance is the silver alloy.

According to such a configuration, the movement of silver in the bonding portion 52B can be suppressed by the silver alloy. Therefore, the occurrence of partial separation between the wavelength conversion layer 56 and the base member 51 can be suppressed. Therefore, it is possible to suppress a decrease in efficiency of the heat transfer from the wavelength conversion layer 56 to the base member 51, and it is possible to suppress a decrease in use efficiency of the blue light BL by the wavelength conversion layer 56, and by extension, to suppress a decrease in efficiency of the conversion from the blue light BL to the fluorescence YL by the wavelength conversion layer 56.

### Third Embodiment

Then, a third embodiment of the present disclosure will be described.

A projector according to the present embodiment includes substantially the same configuration as that of the projector 1 according to the first embodiment, but is different therefrom in the composition of the bonding film provided to the wavelength conversion device. Note that in the following description, the same or substantially the same portions as the portions having already been described are denoted by the same reference numerals, and the description thereof will be omitted.

### Schematic Configurations of Projector and Light Source Device

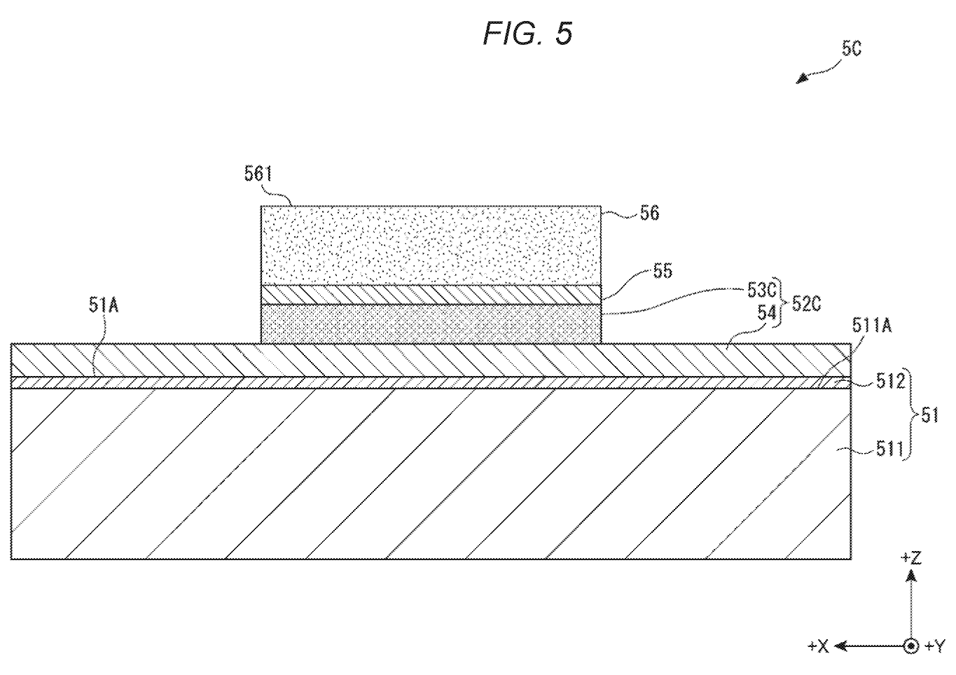

FIG. 5 is a diagram showing a cross-section along the X-Z plane of the wavelength conversion device 5C provided to the light source device of the projector according to the present embodiment.

The projector according to the present embodiment includes substantially the same configuration and functions as those of the projector 1 according to the first embodiment except that the wavelength conversion device 5C illustrated in FIG. 5 is provided instead of the wavelength conversion device 5A according to the first embodiment. That is, the light source device according to the present embodiment includes substantially the same configuration and functions as those of the light source device 4 according to the first embodiment except that the wavelength conversion device 5C is provided instead of the wavelength conversion device 5A.

### Configuration of Wavelength Conversion Device

The wavelength conversion device 5C includes substantially the same configuration and functions as those of the wavelength conversion device 5A according to the first embodiment except that a bonding portion 52C is provided instead of the bonding portion 52A according to the first embodiment. That is, the wavelength conversion device 5C includes the heat dissipation member 57 (not shown in FIG. 5) in addition to the base member 51, the bonding portion 52C, the reflective film 55, and the wavelength conversion layer 56.

The bonding portion 52C has substantially the same configuration and functions as the bonding portion 52A according to the first embodiment except that a bonding film 53C is provided instead of the bonding film 53A according to the first embodiment. That is, the bonding portion 52C includes the bonding film 53C and the bonding member 54, and bonds the base member 51, the reflective film 55, and the wavelength conversion layer 56 to each other.

### Configuration of Bonding Film

The bonding film 53C contains silver (Ag) and also contains silver oxide (Ag₂O) as the movement suppressing substance. Specifically, the bonding film 53C contains silver particles and silver oxide particles.

Here, the silver oxide is a substance which is hard to diffuse in the bonding film 53C. Therefore, the present discloser has found out that the movement of the silver particles due to the stress described above is suppressed by adopting the bonding film 53C containing silver oxide as the movement suppressing substance similarly to the copper particles in the bonding film 53A according to the first embodiment. Therefore, the wavelength conversion device 5C including the bonding film 53C instead of the bonding film 53A can also achieve substantially the same advantages as those of the wavelength conversion device 5A according to the first embodiment.

Note that examples of a method of depositing the bonding film 53C as a bonding film containing silver and silver oxide on the bonding member 54 include a method of performing O₂-assist when depositing silver at the bonding member 54. Accordingly, the bonding film 53C containing silver and silver oxide can be deposited at the bonding member 54.

### Advantages of Third Embodiment

The projector according to the present embodiment described hereinabove provides the following advantages in addition to substantially the same advantages provided by the projector 1 according to the first embodiment.

In the wavelength conversion device 5C, the movement suppressing substance is silver oxide (Ag₂O).

According to such a configuration, movement of silver in the bonding portion 52C can be suppressed by silver oxide (Ag₂O). Therefore, it is possible to provide substantially the same advantages as those of the wavelength conversion devices 5A, 5B.

### Fourth Embodiment

Then, a fourth embodiment of the present disclosure will be described.

A projector according to the present embodiment includes substantially the same configuration as that of the projector 1 according to the first embodiment, but is different therefrom in the composition of the bonding film provided to the wavelength conversion device. Note that in the following description, the same or substantially the same portions as the portions having already been described are denoted by the same reference numerals, and the description thereof will be omitted.

### Schematic Configurations of Projector and Light Source Device

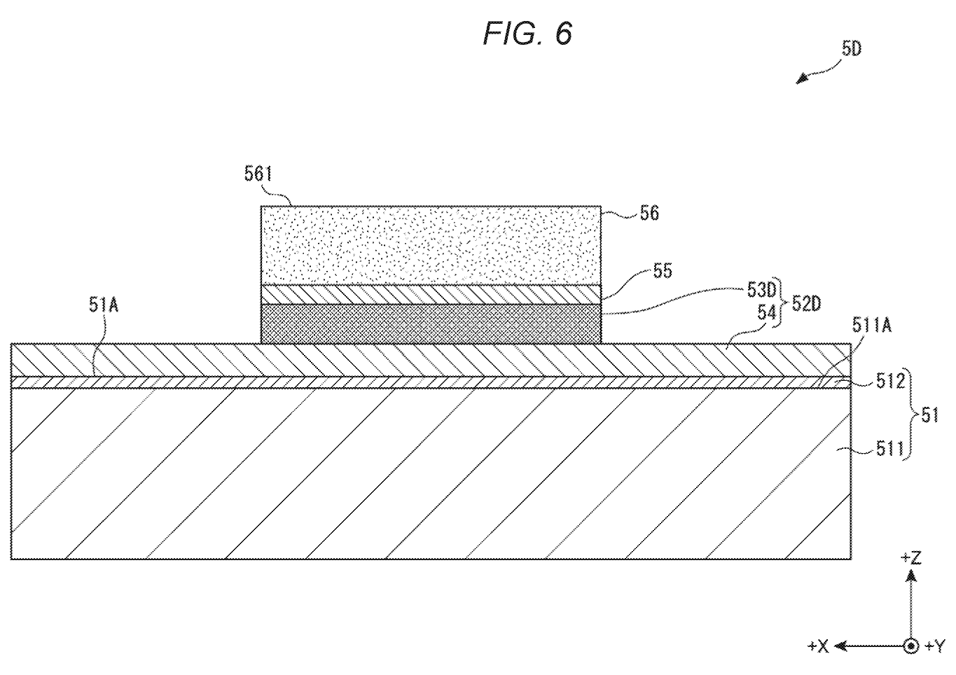

FIG. 6 is a diagram showing a cross-section along the X-Z plane of the wavelength conversion device 5D provided to the light source device of the projector according to the present embodiment.

The projector according to the present embodiment includes substantially the same configuration and functions as those of the projector 1 according to the first embodiment except that the wavelength conversion device 5D illustrated in FIG. 6 is provided instead of the wavelength conversion device 5A according to the first embodiment. That is, the light source device according to the present embodiment includes substantially the same configuration and functions as those of the light source device 4 according to the first embodiment except that the wavelength conversion device 5D is provided instead of the wavelength conversion device 5A.

### Configuration of Wavelength Conversion Device

The wavelength conversion device 5D includes substantially the same configuration and functions as those of the wavelength conversion device 5A according to the first embodiment except that a bonding portion 52D is provided instead of the bonding portion 52A according to the first embodiment. That is, the wavelength conversion device 5D includes the heat dissipation member 57 (not shown in FIG. 6) in addition to the base member 51, the bonding portion 52D, the reflective film 55, and the wavelength conversion layer 56.

The bonding portion 52D has substantially the same configuration and functions as the bonding portion 52A according to the first embodiment except that a bonding film 53D is provided instead of the bonding film 53A according to the first embodiment. That is, the bonding portion 52D includes the bonding film 53D and the bonding member 54, and bonds the base member 51, the reflective film 55, and the wavelength conversion layer 56 to each other.

### Configuration of Bonding Film

The bonding film 53D contains silver (Ag) and additionally contains hydrogen as the movement suppressing substance. Specifically, the bonding film 53D contains silver particles and hydrogen.

Here, the present discloser has found out that the movement of the silver particles due to the stress described above is suppressed by the bonding film containing hydrogen as the movement suppressing substance similarly to the copper particles in the bonding film 53A according to the first embodiment. Therefore, the wavelength conversion device 5D including the bonding film 53D containing silver and hydrogen instead of the bonding film 53A can also achieve the same advantages as those of the wavelength conversion device 5A according to the first embodiment.

Note that examples of a method of forming the bonding film 53D containing silver and hydrogen include a method of introducing hydrogen into the bonding film by performing a high-temperature annealing treatment on the bonding film containing silver in a hydrogen atmosphere. Therefore, the bonding member 54 also contains hydrogen.

### Advantages of Fourth Embodiment

The projector according to the present embodiment described hereinabove provides the following advantages in addition to substantially the same advantages provided by the projector 1 according to the first embodiment.

In the wavelength conversion device 5D, the movement suppressing substance is hydrogen.

According to such a configuration, the movement of silver in the bonding portion 52D can be suppressed by hydrogen contained in the bonding portion. Therefore, it is possible to provide substantially the same advantages as those of the wavelength conversion devices 5A, 5B, and 5C.

### Modifications of Embodiments

The present disclosure is not limited to each of the embodiments described above, and modifications, improvements, and so on within a range in which the object of the present disclosure can be achieved should fall within the scope of the present disclosure.

In the embodiments described above, copper, a silver alloy, silver oxide (Ag₂O), and hydrogen are exemplified as the movement suppressing substance. However, this is not a limitation, and other substances may be adopted as long as the movement of silver in the bonding portions 52A, 52B, 52C, and 52D can be suppressed.

In the embodiments described above, the bonding portions 52A, 52B, 52C, and 52D include the bonding films 53A, 53B, 53C, and 53D containing silver and the movement suppressing substance, respectively, and the bonding member 54 containing silver nanoparticles. However, this is not a limitation, and the configuration of the bonding portion is not limited to the above. For example, the bonding portion may include another layer.

In the first embodiment described above, the ratio of copper to silver in the bonding film 53A is 1/400 or more and 3/100 or less in terms of molar number. However, this is not a limitation, and the ratio can be changed as appropriate, and is not necessarily required to be in the range of 1/400 or more and 3/100 or less.

In the first embodiment described above, copper as the movement suppressing substance is disposed in the form of a layer in the bonding film 53A. That is, the movement suppressing layer 533 configured with copper is formed in the bonding film 53A. However, this is not a limitation, and it is sufficient for copper as the movement suppressing substance to be contained in the bonding film 53A.

In the embodiments described above, the light modulation device 34 of the projector includes the three light modulation elements 343R, 343G, and 343B. However, this is not a limitation, and the present disclosure is also applicable to a projector including two or fewer or four or more light modulation elements.

In the embodiments described above, the transmissive liquid crystal panel in which the light incident surface and the light exit surface are different is exemplified as the light modulation element 343, but a reflective liquid crystal panel in which the light incident surface and the light exit surface are the same may be adopted. Further, a light modulation device using any element other than the liquid crystal-based element, such as a device using micromirrors, for example, a digital micromirror device (DMD), may be used as long as the light modulation device is capable of modulating the incident light flux to form an image according to image information.

In the embodiments described above, there is cited an example in which the light source device according to the present disclosure is applied to the projector. However, this is not a limitation, and the light source device according to the present disclosure may be adopted in an electronic apparatus other than the projector, such as a lighting fixture and a headlight of an automobile.

Further, the configuration of each of the projector and the light source device is not limited to the configuration exemplified in each of the embodiments described above, and can be appropriately changed. For example, it is sufficient for the light source device to include at least a light source and a wavelength conversion device, and the rest of the configuration can be changed as appropriate.

### SUMMARY OF PRESENT DISCLOSURE

A summary of the present disclosure will be appended below.

### Appendix 1

A wavelength conversion device including: a base member having a first face; a wavelength conversion layer disposed at an incident side of first light in a first wavelength band with respect to the base member and configured to convert the first light incident thereon into second light in a second wavelength band different from the first wavelength band; a reflective film disposed between the wavelength conversion layer and the first face and configured to reflect light incident thereon from the wavelength conversion layer; and a bonding portion disposed between the reflective film and the first face and configured to bond the reflective film and the base member to each other, wherein the bonding portion contains silver and a movement suppressing substance configured to suppress movement of silver.

According to such a configuration, since the bonding portion contains the movement suppressing substance that suppresses the movement of silver, it is possible to suppress a decrease in bonding strength with the bonding portion due to the movement of silver over time. Therefore, the occurrence of partial separation between the wavelength conversion layer and the base member can be suppressed. Therefore, it is possible to suppress a decrease in efficiency of the heat transfer from the wavelength conversion layer to the base member, and it is possible to suppress a decrease in use efficiency of the first light by the wavelength conversion layer, and by extension, to suppress a decrease in efficiency of the conversion from the first light to the second light by the wavelength conversion layer.

### Appendix 2

The wavelength conversion device according to Appendix 1, wherein the bonding portion includes a bonding film containing silver and the movement suppressing substance, and a bonding member that contains silver nanoparticles, is disposed at the base member side of the bonding film, and is bonded to the bonding film.

According to such a configuration, since the bonding portion includes the bonding film and the bonding member, the bonding strength between the reflective film and the base member with the bonding portion can be increased.

Further, since the bonding film contains the movement suppressing substance, silver in the bonding film is prevented from moving to the bonding member side to cause the reflective film and the bonding film to be partially separated from each other. Therefore, it is possible to suppress a decrease in efficiency of the heat transfer from the wavelength conversion layer to the base member via the reflective film, and it is possible to suppress a decrease in the use efficiency of the first light by the wavelength conversion layer.

### Appendix 3

The wavelength conversion device according to Appendix 2, wherein the base member includes a substrate having a first surface, and a metal film containing a noble metal and disposed at the first surface, and the metal film forms the first face.

According to such a configuration, the bonding strength between the base member and the bonding member can be increased.

### Appendix 4

The wavelength conversion device according to Appendix 2 or 3, wherein the movement suppressing substance is copper.

According to such a configuration, movement of silver is suppressed by copper. Accordingly, it is possible to effectively achieve the effect described above.

### Appendix 5

The wavelength conversion device according to Appendix 4, wherein a ratio of copper to silver in the bonding film is 1/400 or more and 3/100 or less in terms of molar number.

Here, when the ratio of copper to silver is low, the effect of suppressing the movement of silver is low, whereas when that ratio is high, copper is deposited on the surface of the bonding film and the bonding strength is reduced.

To cope with the above, by setting the ratio of copper to silver within the range described above, it is possible to suppress each of the decrease in bonding strength due to movement of silver and the decrease in bonding strength due to precipitation of copper. Accordingly, it is possible to effectively achieve the effect described above.

### Appendix 6

The wavelength conversion device according to Appendix 4 or 5, wherein the movement suppressing substance is disposed as a layer between a first end surface at the base member side of the bonding film and a second end surface at the wavelength conversion layer side of the bonding film.

According to such a configuration, copper can be efficiently introduced into the bonding film, and in addition, the movement of silver can be effectively suppressed by copper as a layer. Accordingly, it is possible to effectively achieve the effect described above.

### Appendix 7

The wavelength conversion device according to any one of Appendices 1 to 3, wherein the movement suppressing substance is a silver alloy.

According to such a configuration, the movement of silver can be suppressed by the silver alloy. Accordingly, it is possible to effectively achieve the effect described above.

### Appendix 8

The wavelength conversion device according to any one of Appendices 1 to 3, wherein the movement suppressing substance is silver oxide.

According to such a configuration, the movement of silver can be suppressed by silver oxide (Ag₂O). Accordingly, it is possible to effectively achieve the effect described above.

### Appendix 9

The wavelength conversion device according to any one of Appendices 1 to 3, wherein the movement suppressing substance is hydrogen.

According to such a configuration, movement of silver can be suppressed by hydrogen contained in the bonding portion. Accordingly, it is possible to effectively achieve the effect described above.

### Appendix 10

A light source device including: a light source configured to emit the first light; and the wavelength conversion device according to any one of Appendices 1 to 9 on which the first light emitted from the light source is incident.

Such a light source device can achieve substantially the same advantages as those of the wavelength conversion device described above. Therefore, since the efficiency of the wavelength conversion from the first light to the second light by the wavelength conversion device is improved, the luminance of the light emitted from the light source device can be increased.

### Appendix 11

A projector including: a light source device according to Appendix 10; a light modulation device configured to modulate the light emitted from the light source device; and a projection optical device configured to project the light modulated by the light modulation device. Such a projector can achieve substantially the same advantages as those of the light source device described above. Accordingly, it is possible to improve the luminance of an image to be projected from the projector.

What is claimed is:

1. A wavelength conversion device comprising:
a base member having a first face;
a wavelength conversion layer disposed at an incident side of first light in a first wavelength band with respect to the base member and configured to convert the first light incident thereon into second light in a second wavelength band different from the first wavelength band;
a reflective film disposed between the wavelength conversion layer and the first surface and configured to reflect light incident thereon from the wavelength conversion layer; and
a bonding portion disposed between the reflective film and the first surface and configured to bond the reflective film and the base member to each other, wherein
the bonding portion contains silver and a movement suppressing substance configured to suppress movement of silver.

2. The wavelength conversion device according to claim 1, wherein
the bonding portion includes
a bonding film containing silver and the movement suppressing substance, and
a bonding member that contains silver nanoparticles, is disposed at the base member side of the bonding film, and is bonded to the bonding film.

3. The wavelength conversion device according to claim 2, wherein
the base member includes
a substrate having a first surface, and
a metal film containing a noble metal and disposed at the first surface, and
the metal film forms the first face.

4. The wavelength conversion device according to claim 2, wherein
the movement suppressing substance is copper.

5. The wavelength conversion device according to claim 4, wherein
a ratio of copper to silver in the bonding film is 1/400 or more and 3/100 or less in terms of molar number.

6. The wavelength conversion device according to claim 4, wherein
the movement suppressing substance is disposed as a layer between a first end surface at the base member side of the bonding film and a second end surface at the wavelength conversion layer side in the bonding film.

7. The wavelength conversion device according to claim 1, wherein
the movement suppressing substance is a silver alloy.

8. The wavelength conversion device according to claim 1, wherein
the movement suppressing substance is silver oxide.

9. The wavelength conversion device according to claim 1, wherein
the movement suppressing substance is hydrogen.

10. A light source device comprising:
a light source configured to emit the first light; and
the wavelength conversion device according to claim 1 on which the first light emitted from the light source is incident.

11. A projector comprising:
a light source device according to claim 10;
a light modulation device configured to modulate the light emitted from the light source device; and
a projection optical device configured to project the light modulated by the light modulation device.
